(19) United States
(12) Patent Application Publication
(10) Pub. No.: US 2010/0228584 A1
(43) Pub. Date: Sep. 9, 2010

(54) PREDICTIVE RISK INTELLIGENT SAFETY MODULE

(76) Inventor: David E. Nash, Littleton, CO (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/719,421

(22) Filed: Mar. 8, 2010

Related U.S. Application Data
(60) Provisional application No. 61/209,432, filed on Mar. 6, 2009.

(51) Int. Cl. G06Q 10/00; G06Q 50/00

(52) U.S. Cl. 705/7; 705/320; 705/32

(57) ABSTRACT

Systems and methods for assessing and reporting fatigue risk in real time and for providing fatigue countermeasures are disclosed. The system includes electronic and software systems that predict and preempt fatigue risk by calculating, based on historical work schedule patterns, risk ranges or levels, and provides in real time a graphical risk output and countermeasures to reduce risk. High risk personnel can be automatically reported to management for further evaluation. A lifestyle plan based on historical work schedules and planned work scheduled are generated and provided to personnel. Risk assessment can be performed at any time, including when beginning or ending work, or on-demand.

### CROSS-REFERENCE TO RELATED APPLICATIONS

This application claims the benefit of Application Ser. No. 61/209,432, filed on Mar. 6, 2009, which is hereby incorporated by reference.

### TECHNICAL FIELD

The present invention relates generally to fatigue monitoring and measuring systems and, more particularly, to systems and methods for identifying and reporting fatigue risk in real-time and for providing fatigue countermeasures.

### BACKGROUND

Shift work typically involves workers working for various amounts of time throughout a day. Work shifts may occur at any time during the day, and are often not synchronized with the natural sleep and waking patterns of those who work the shifts. Assessing fatigue due to shift work or for any other reason has historically been a subjective, narrow effort. Many managers neither acknowledge nor take adequate preemptive steps to mitigate risks due to excessive fatigue. Moreover, while workers may recognize their own fatigue at some level, they often underestimate dangerous fatigue levels and engage in habits that promote unnecessary safety risks.

Tens of millions of shift workers are affected by the risks of fatigue. Shift workers' generally poorer health is at least partially due to a lack of systems that use real-time schedule-specific fatigue management to measurably improve their lives. Communities-at-large also suffer due to fatigue-related driving fatalities and accidents as well as a fatigue-induced lack of vigilance among shift workers performing safety-critical tasks. Examples of catastrophic fatigue-related errors and accidents abound, such as accidents directly caused by fatigued workers (e.g. air traffic controllers, rail engineers, bus drivers) and accidents caused indirectly due to fatigue (e.g., Chernobyl, Three-Mile-Island, Bhopal, the Exxon Valdez). Besides safety, the economic costs to consumers, governments, and companies due to fatigue are staggering, numbering in the billions of dollars annually worldwide.

At present, there exists no system or means of warning the worker and/or the worker's employer of over-working an individual to the point of being a danger to themselves and those around them. Some industries (e.g. nuclear, railroad, trucking) have put in prescriptive regulation rules to limit hours of work but the application of such rules are limited to a general number of hours in a given period. There is no system available that helps both the worker and the employer understand in real-time the accumulative fatigue condition of the worker over a given period of time. For example, a person may work a normal twelve hour night shift from 7:00 PM to 7:00 AM and may then be asked to work another four hours while a replacement worker is located. After the continuous sixteen hours of work, the worker leaves for home, but may then be asked to come in two hours early for a meeting on top of his normal twelve hour shift. In most cases neither the worker, nor the worker's supervisor or manager, is aware of what risk is accumulating that could put the worker and/or the workplace in jeopardy. While some alertness, performance, and/or risk measurements may show that at the end of two such work day cycles the worker would be at high risk for driving home, there is no currently available system to warn the worker and/or his or her employer of a potential fatigue-related problem, nor is there any system available to provide any countermeasures to address this level of fatigue and mitigate the problem.

Devices exist to allow the monitoring of current alertness levels. For example, in U.S. Pat. No. 4,540,979 to Gerger (1985), a grip-responsive operator alertness monitor is described which includes a pressure sensor associated with a mechanism for controlling a vehicle. The pressure sensor detects operator fatigue as exhibited by a change in operator pressure on the control mechanism. An operator stimulus is coupled to the pressure sensor and, upon sensing fatigue, produces a stimulus such as a visual or audible alarm. Another device, disclosed in U.S. Pat. No. 4,397,531 to Lees (1983), determines whether an eye within a field of view is closed for a predetermined period of time. If so, the assumption is made that the subject has fallen asleep, so that corrective measures can be taken, such as the sounding of an alarm. All of the above-referenced devices are designed to monitor current alertness level. None of them predict risk in any way, nor do they determine the level of risk or address countermeasures based on risk level.

Accordingly, a need exists for a system which provides a means to perceive fatigue at the earliest stage thereof and to identify and implement appropriate countermeasures, thereby increasing health, safety, and welfare of individuals, as well as preempting increasing safety, health, and performance costs of shift work and other types of work.

### SUMMARY

Systems and methods are disclosed for assessing fatigue risks and addressing such risks. In one embodiment, a worker may operate a terminal, time clock, or other device to establish time data associated with the beginning or ending a work shift. The time data may then be used in conjunction with historical time data to determine a risk score, level, rating, or category for the worker, which may be presented to the worker. The determined risk score, level, rating or category may also be transmitted or otherwise provided to a supervisor, manager, or other appropriate personnel. A further determination may be made as to whether the risk level, rating or category is associated with a safe or unsafe level of risk. This determination may be based, at least in part, on the job or tasks associated with the worker. Based on this determination and/or the determination of the risk level, rating or category, countermeasures may be provided to the worker and/or the worker's management that are intended to reduce or address the determined risk.

In some embodiments, a lifestyle plan may also be generated and presented to a worker when the worker interacts with a system as disclosed herein. The lifestyle plan may be generated based on the historical work schedule and the future work schedule of the worker. The lifestyle plan may include recommendations and suggestions for lowering the fatigue risk of the worker and increasing alertness. Such recommendations may include recommended sleep periods, recommended exercise periods and types of exercise, and a recommended diet and times for eating.

Workers may request fatigue risk data and related information at various times in addition to, or instead of, the beginnings and ends of shifts. At such times, countermeasures for predicted fatigue levels may also be provided. Workers may be periodically required to interact with a risk assessment system throughout a work shift to insure that they are capable of safely continuing their work. Random interaction with a risk assessment system may be required to achieve the same goal. In one embodiment, a worker may interact with a risk assessment system before coming to work to determine the worker's fatigue risk in advance. Such a worker may at that time also obtain countermeasures to use in preparation for a shift. Workers and other users of a risk assessment system may interact with a risk assessment system using any effective means, including through a dedicated terminal, through a remote computer (in one embodiment, via the Internet), and through a voice communications system. Output provided to workers and other users may also be provided by a printer providing paper copies of such output

Aggregated worker fatigue risk data may be gathered and processed for use by management and others that have a need to assess and act on the fatigue risks experienced by an organization or other group of workers. Such data may be presented to a user in a graphical format and may allow the user to select a subset of the workers or an individual worker and obtain fatigue risk details relating to that subset or individual worker. These and additional aspects of the current disclosure are set forth in more detail below.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 illustrates a non-limiting exemplary environment in which risk assessment methods and systems may be implemented.

FIG. 2 illustrates a non-limiting exemplary method of implementing risk assessment.

FIG. 3 illustrates a non-limiting exemplary lifestyle plan.

FIG. 4 illustrates a non-limiting exemplary view that may be presented to a worker interacting with a risk assessment system.

FIG. 5 illustrates a non-limiting exemplary view that may be presented to a manager or other person desiring aggregate risk data from a risk assessment system.

### DETAILED DESCRIPTION OF ILLUSTRATIVE EMBODIMENTS

Referring now to the figures, a system for identifying and reporting fatigue risk in real time and for providing fatigue countermeasures is described. The present systems and methods (which may be hereinafter referred to as “PRISM”) calculate and/or determine the probability and/or severity of fatigue risk, in some embodiments in real-time. In some embodiments, such calculations and determinations may be performed at predetermined times (such as punch-in and punch-out, at the beginning or end of shifts, at predetermined points in a shift, etc.), upon demand, or at random times. Recommendations and countermeasures may be provided that improve shift worker safety and performance pre-shift, on-shift, and post-shift, including the drive to and from work. Using historical data and predictive analytics, the present systems and methods also improve management's ability to enhance overall safety, health, and efficiency of employees and worksites through prospective, real-time, and retrospective analyses that model distributed risk across multiple periods by shift, day, week, 4-week rotation, quarter, year, or any timeframe of interest. Note that the term “risk analysis” as used throughout the present specification indicates any analysis, calculation, and/or determination of present, past or future fatigue level, alertness level, mental and/or physical state of a worker or group of workers, health of a worker or group of workers, or any other measurement, score, level, or ranking of any trait of a worker that may be of interest. A risk analysis server, computer, system, and/or device as described herein refers to any number of devices, components, or other elements that may be used, at least in part, in risk analysis and/or determination of related data.

While there currently exists a variety of methods to calculate or determine alertness and/or performance, such methods have not typically been scientifically validated within the science specialty, even though such methods may perform reasonable prediction. Mechanical and electronic time and attendance systems utilizing a time clock have been in existence for many years. Examples of such time systems include manual punch cards used with a mechanical time stamping machine and electronic devices that detect and recognize thumb or finger prints, palm prints, or portions of a human eye. The present systems and methods provide an interface that coordinates a time system and risk assessment system and then produces graphical countermeasures for immediate user consumption. The present disclosure further provides an integrative program that captures data on individual users, such as a number of real work hours over a period of time, calculates the risk due to fatigue, and provides graphically represented science standard countermeasures for immediate application by a user. Data collection and presentation can take place at any point during a workday, and the periods of time analyzed may be any that are useful.

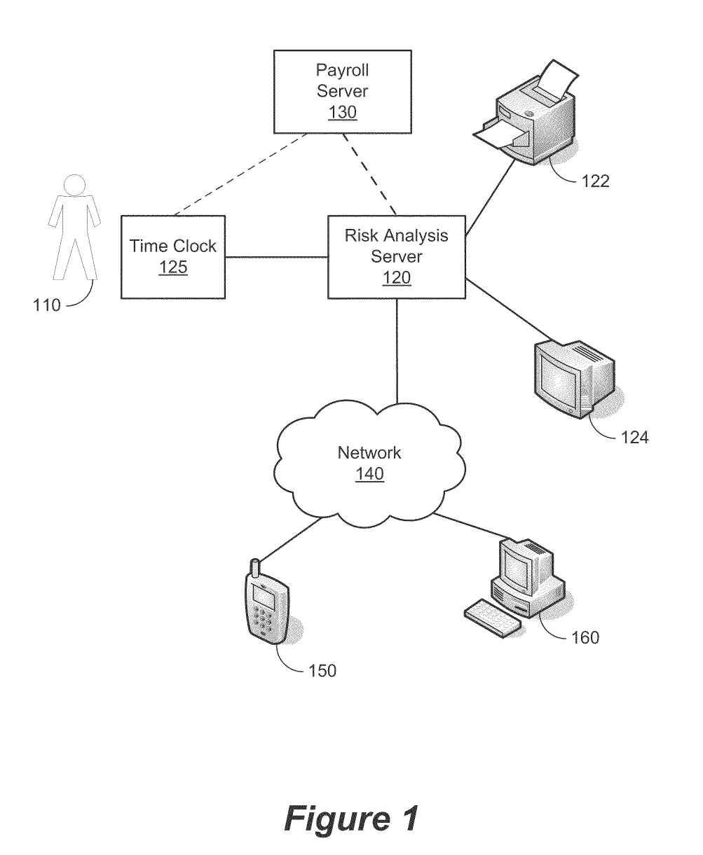

FIG. 1 represents a system in which the present disclosure may be implemented. User 110 may be an employee, contractor, worker, or any other person who is a user of the present systems and methods, and/or is evaluated or analyzed by the presently disclosed systems and methods. In one embodiment, user 110 may be a shift worker who works various shifts within a certain time period and therefore may be susceptible to fatigue and the risks associated therewith. For example, user 110 may work morning, afternoon, and night shifts variously throughout a two week time period, and therefore, due to the lack of coordination between the shifts worked and user 110's natural sleep/wake cycle, user 110 may be susceptible to fatigue-induced accidents or other consequences of fatigue.

User 110 may operate time clock 125. Time clock 125 may be any device, mechanical or electrical, of any type that may be configured for establishing a time when activated and thereby recording, or assisting in the recording, of times worked. For example, time clock 125 may be a simple mechanical time clock that makes a mechanical notation of the time when user 110 “punches in”. Alternatively, time clock 125 may be a computer or other electronic device that, when operated by a user, records or causes to record a time of operation. In yet another embodiment, time clock 125 may also, or instead, serve as a check-in type device that, when activated, communicates with risk analysis server 120 to initiate or participate in risk analysis. Any type of time clock or any means for recording or acquiring time is contemplated as within the scope of the present disclosure.

When activated or operated by user 110, time clock 125 may communicate with risk analysis server 120. Such communication may be of any type, including electronic and mechanical. In the embodiments where time clock 125 is configured to communicate electronically with risk analysis server 120, such communication may be wired or wireless, or a combination of wired and wireless communication. Such communication may occur directly between these two devices, or there may be one or more intermediate devices and/or networks through which such communication may travel. Any electronic, telecommunications, or signaling communications means may be employed. Such communication may be one-way or two-way, and may be half- or full-duplex. All such communications are contemplated as within the scope of the present disclosure.

Risk analysis server 120 may be any electronic or computing device designed to implement the methods and systems described in more detail herein. Risk analysis server 120 may be one device or may represent two or more communicatively connected devices. Risk analysis server may be configured to communicate with a variety of other device and/or peripheral devices, such as printer 122 and/or monitor 124. Any type of server, computing device, or other electrical device, or any number or combination of such devices, may perform the risk analysis described herein, and all such configurations are contemplated as within the scope of the present disclosure.

Alternatively, risk analysis server 120 may represent a software program that may be integrated into a time and/or attendance device, system or software, which may provide the interfaces to the risk analysis system represented by risk analysis server 120, and which may be configured to control the operation of the risk analysis system represented by risk analysis server 120. Any software embodiment of a risk analysis system as disclosed herein, and any method or means of storing such an embodiment, including storing computer-readable instructions for performing the methods disclosed herein on a tangible storage medium such as a magnetic or optical disk, are contemplated as within the scope of the present disclosure.

In yet another alternative, risk analysis server 120 may represent a remote system that is accessed by an employer for the purposes of risk assessment. For example, risk analysis server may represent a risk assessment service that is accessed based on a licensing arrangement or provided as a “software as a service”. Access to such a system may be through dedicated communications means or through a public network such as the Internet. Any embodiments of a risk assessment system where the computing devices and/or software performing risk assessment are remotely located to the employer are contemplated, and any method or means of implementing such an embodiment, are contemplated as within the scope of the present disclosure.

Upon completing risk analysis, results, plans, and any other data may be presented to a user, a manager, or to any other interested party through peripheral devices such as printer 122 and/or monitor 124. Alternatively, or in conjunction, results may be provided via network 140 to other devices, such as mobile communications device 150 or computer 160. Mobile communications device 150 may be any type of mobile or wireless communications device, such as a mobile telephone, personal data assistant (PDA), mobile computer, laptop, netbook, smartphone, or any other communications device or computer capable of receiving electronic communications. Mobile communications device 150 may also be a landline telephone and may provide data to a user through audible signals, such as a voice recording or computer-generated speech. Computer 160 may be any type of computing device, including a laptop, desktop, server, client, mainframe, or any other device capable of receiving data communications and conveying information to a user.

Note that in some embodiments, rather than using time clock 125, user 110 may operate a remote device in order to interact with risk analysis server 120. For example, user 110 may operate mobile communications device 150 in order to “punch in” or otherwise indicate to risk analysis server 120 that user 110 has arrived at work or has begun working. Similarly, user 110 may operate computer 160 to perform the same function. In other embodiments, user 110 may use a device, such as mobile communications device 150 or computer 160, to periodically, or upon request, interact with risk analysis server 120. For example, user 110 may call into risk analysis server 120 prior to a shift to provide data and/or obtain fatigue risk data as well as countermeasures that may be performed prior to beginning a shift. In this way, user 110 may proactively reduce the fatigue risk before starting work. User 110 may use any combination of these means in order to interact with and/or obtain results and/or plans from rick analysis server 120. All such embodiments are contemplated as within the scope of the present disclosure.

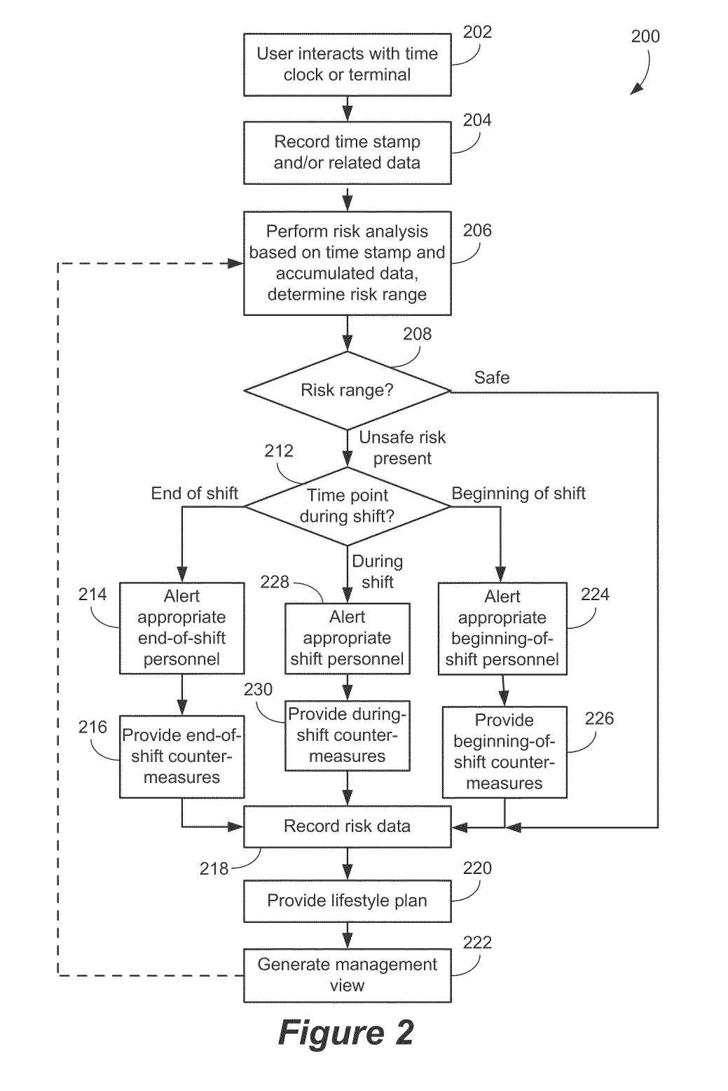

FIG. 2 illustrates a method 200 of implementing one embodiment of present disclosure. Note that the activities associated with the blocks set forth in FIG. 2 may be performed in any order, and may be performed in conjunction with other activities not shown in FIG. 2. Moreover, one or more of the blocks in FIG. 2 and their associated activities may be performed in isolation or in conjunction with activities associated with other blocks in FIG. 2, without performing all of the activities associated with the blocks of FIG. 2. All such embodiments are contemplated as within the scope of the present disclosure.

In some embodiments, the presently disclosed risk assessment system may interface with time and/or attendance systems and may identify human fatigue risk and provide alertness countermeasures at certain times. Such time may include punch-in and punch-out at the beginning and end of a shift, periodic check-ins, or randomly selected times. In some embodiments, fatigue risk may be assessed only at the beginning and end of a shift, where in other embodiments, work rules may require that workers interface with the presently disclosed system periodically. Such periodic interface with a risk assessment system may be at scheduled times, for example, twice during a shift, or may be at random time, with times and workers selected by a manager or supervisor as the manager or supervisor sees fit, or randomly selected using any other means, such as a computer program. Such a computer program may be integrated into the presently disclosed risk assessment systems and methods.

At block 202, a worker may interact with a time clock or other terminal, interface, or any other means, in order to provide data to a risk assessment system. This data may be merely an indication that the worker is present and ready to begin a shift, such as is typically collected with a time clock system. Such data may include a worker identifier, name, or other data that allows a risk assessment system to locate historical data for the worker. Data may be provided using any means or method, including via a time clock operating on traditional time cards, the detection of magnetic strips on worker identification cards, detection of worker data via radio frequency identification, a worker manually operating a keyboard or other peripheral device to enter worker data, voice, fingerprint, retinal, or other physiologically based recognition methods, etc.

Alternatively, or in conjunction, the worker may provide additional data beyond time of interaction with a time clock or other terminal. Such data may include health or habit data obtained directly from the worker or from a health monitoring device that has collected such data. For example, a worker may provide at block 202 the number of hours the worker has slept since the last interaction with a time clock or terminal of a risk assessment system, or any other health or habit data that may be useful. Alternatively, a worker may wear or interact with a cell phone, wristwatch, or other device that actively monitors the worker's sleep and/or waking activity, physical activity, smoking, diet, etc. Information collected with such a health monitoring device may be provided to a risk assessment system at block 202. Alternatively, such data may be provided via data communications from a health monitoring device on a continuous or periodic basis regardless of whether the worker is personally interacting with the time clock, terminal, or other device that is part of a risk assessment system. All such embodiments are contemplated as within the scope of the present disclosure.

At block 204, any data collected at block 202 may be recorded. This may be as simple as transmitting punch-in or punch-out times to a payroll or attendance system, a regulatory compliance system, a system for tracking rates of accrual, etc. Alternatively, or in conjunction, a risk assessment system may record the information collected at block 202 in a database, and may also, or instead, transmit such information to other devices for analysis and/or storage. Data may be recorded and maintained by a risk assessment system for a limited amount of time or indefinitely. Such data may be associated with a worker using any means, including means that allow the worker to be anonymous within the risk assessment system. In such systems, a worker may be only identified by a personal account number or other identifier that does not include the worker's actual name or identifiable data such as a social security number. Data may be recorded using any means of data recordation and storage, including in memory, on magnetic, optical, or any other type of disk, or on any other human- or computer-readable medium. Any recording and/or further manipulation of data collected from workers using any means is contemplated as within the scope of the present disclosure.

At block 206, risk analysis is performed, in one embodiment using data collected at block 202. In some embodiments, the results of such risk analysis may be in the form of a score or grade, or range of scores or grades, that falls at some point along a risk spectrum. In one embodiment, an organization, company, or agency utilizing risk assessment methods or systems will have determined their own risk range by job classification. A risk range may be the levels of risk that the organization, company, or agency has determined should trigger the activation of countermeasures given the level of risk associated with a particular job or task. For example, a person in a job classification of performing data entry may be permitted a higher risk tolerance, and thus a higher risk range than a bus driver operating a bus carrying passengers. Such ranges may be associated with colors and/or labels that make it easy to identify the risk range in which a worker falls, discussed in more detail below. For example, in Table 1 below, a non-limiting exemplary table of risk ranges is shown with the corresponding labels and colors:

TABLE 1
Risk ranges and corresponding labels, colors, and other data

| | | | | Potential % | | |
|---|---|---|---|---|---|---|
| Risk Scale | | | | exposure | | |
| Signia | Signia | | | and/or | Alertness Scale | |
| Risk | Refined | | | diminished | Strategy | Strategy |
| (5 point) | (7 point) | Scale | Risk Range | capacity | (5 point) | (7 point) |
| Low (green) | Normal | 10 | 9.51-10+ | 0% | Maintain | Optimal |
| | (blue) | 9 | 8.51-9.50 | 5% | | |
| | | 8 | 7.51-8.5 | 10% | | |
| | Low | 7 | 6.51-7.5 | 15% | | Maintain |
| | (green) | 6 | 5.51-6.5 | 20% | | (Preserve- |
| | | 5 | 4.51-5.5 | 25% | | Conserve) |
| Guarded | Guarded | 4 | 3.51-4.5 | 30% | Protect | Protect |
| (yellow) | (yellow) | 3 | 2.51-3.5 | 35% | | (Watchful/ |
| | | 2 | 1.51-2.5 | 40% | | Attentive) |
| Significant | Significant | 1 | 0.51-1.5 | 45% | Guard | Guard |
| (orange) | (orange) | 0 | 0.51-(−0.50) | 50% | | (Shield/ |
| | | −1 | −0.51-(−1.50) | 55% | | Defense) |
| High | High | −2 | −1.51-(−2.50) | 60% | Proactive | Proactive |
| (red) | (red) | −3 | −2.51-(−3.50) | 65% | | (Active/ |
| | | −4 | −3.51-(−4.50) | 70% | | Control) |
| Severe | Severe | −5 | −4.51-(−5.50) | 75% | Vigilant | Vigilant |
| (purple) | (purple) | −6 | −5.51-(−6.50) | 80% | | (Cautious/ |
| | | −7 | −6.51-(−7.50) | 85% | | Alert) |
| | Extreme | −8 | −7.51-(−8.50) | 90% | | Priority 1 |
| | (grey) | −9 | −8.51-(−9.50) | 95% | | |
| | | −10 | −9.51-(−10+) | 100% | | |

Note that any method or means of calculating or determining a risk range or any similar measurement of fatigue may be used at block 206. In one embodiment, a risk assessment system may have configured within it predictive risk intelligent safety measurement software that calculates the level of risk derived from a predetermined amount of time. For example, a risk assessment system may evaluate the prior seven days using worker data such as punch-in and punch-out times, against known and established fatigue level measurements, known as fatigue index risk measurements (FIRM). Methods used to determine a risk range or other risk assessment results may include those described in well known studies and publications (for example, “Subjective and Objective Sleepiness in the Active Individual” by Akerstedt et al., International Journal of Neuroscience, 1990, vol. 52, pages 29-37; “An Algorithm for Shift Scheduling which considers Circadian Principles” by Kostreva et al., International Journal of Industrial Ergonomics, 1991, pages 317-322; “Rhythms in sleep and fatigue—A Model” by Akerstedt and Folkard, Abstract of 32 Congress of International Union of Physiological Sciences, August 1993.) The calculations and determination performed at block 206 may be performed automatically upon receiving data from a worker, such as at punch-in or punch-out, or may be performed upon receipt of an explicit instruction to do so. Any number of days or any period of time may be used in performing the analysis of block 206, and all such embodiments are contemplated as within the scope of the present disclosure.

At block 208, a decision may be made at to whether the risk analysis performed at block 206 resulted in a safe or unsafe risk range for the worker. This may include evaluating a risk range determined for a worker at block 206 and determining whether the risk range falls into an alertness scale category or risk scale category (as seen in Table 1) that has been deemed unsafe for the particular worker. For example, if Joe Driver is a bus driver, and he obtains a 7.2 risk score, thus placing him in the 6.51-7.5 risk range of Table 1, he may be deemed safe to proceed with work as his risk range is within the Low risk scale category and/or the Maintain alertness scale category, which may have been established as safe categories for a worker performing the type of work performed by Joe Driver. On the other hand, if Joe Driver obtains a 1.2 risk score, thus placing him in the 0.51-1.5 risk range of Table 1, he may be deemed unsafe to proceed with work as his risk range is within the Significant risk scale category and/or the Guard alertness scale category, which may have been established as unsafe categories for a worker performing the type of work performed by Joe Driver.

Different jobs and/or tasks may have different acceptable risk levels, thereby altering the safe and unsafe risk categories for various jobs. Whereas Joe Driver may be deemed to be in an unsafe state of fatigue when obtaining a 1.2 risk score, Dana Dataentry may be deemed to be in a safe state of fatigue with a similar score. Note that the association of risk levels and categories with risk scores may be user configurable. For example, an employer may determine which risk scores or risk ranges are associated with unsafe and safe rick levels. Alternatively, the association between levels and scores may be predetermined by a provider of a risk assessment system. At block 208, a risk analysis system may determine a job category, job type, or other parameter of a job or task associated with a worker, and then use that information to determine whether the worker is in the safe or unsafe risk categories for the worker's respective job classification or type. Any method or means of assigning categories and/or risk ranges as safe or unsafe based on particular jobs or tasks to be performed, worker history, worker training, worker experience, or any other information or data, may be used in conjunction with the presently disclosed systems and methods, and all such means and methods are contemplated.

If, at block 208, a worker's risk range is determined to be in a safe category or otherwise deemed safe, the risk data and results of risk analysis may be recorded at block 218 using any effective means, including those described in regards to block 204.

If, at block 208, a worker's risk range is determined to be in an unsafe category or otherwise deemed unsafe, then at block 212 a determination is made as to the current time point of the worker's shift. This determination may be helpful in determining what steps to take to address the unsafe fatigue level currently assessed to the worker. Any method or means may be used to determine the current time point of the worker's shift. Note that in some embodiments, for example where a worker periodically interacts with a risk assessment system or interacts without necessarily accounting for whether the worker is beginning or ending a shift, there may not be a need to determine whether the worker is beginning or ending a shift. In such embodiments, block 212 may not be performed, and any of the remaining blocks of method 200 may be performed in any order.

Note that, in some embodiments, a risk assessment system may continuously update risk levels and risk ranges for workers based on known or acquired fatigue data throughout a shift or at times outside of a worker's shift. For example, while a risk assessment system may determine at time of punch-in that a worker is at a safe level of risk, the risk assessment system may predict that the worker will be experiencing an unsafe level of fatigue approximately four hours after punch-in. The risk assessment system may then proactively notify the worker and/or management at that time and may perform steps disclosed herein to provide countermeasures and guidance (described in more detail below) that will assist in reducing fatigue and/or risk due to fatigue. Such notification may occur via any communications means described herein.

If a worker at the beginning of a shift, at block 224, the appropriate personnel may be alerted to the worker's unsafe fatigue determination. Because the worker is at the beginning of a shift, the worker's immediate supervisor may be notified, who may then perform an in-person evaluation of the worker before allowing him or her to begin work. Other personnel that are suited for addressing fatigued workers during a work shift may be notified. The notification may include a print out that the worker is required to supply to a supervisor or manager, or an email, text message, “Tweet”, automated voice message, or other electronic communication may be transmitted to the supervisor or other appropriate personnel. Any means of notifying the appropriate personnel may be used.

At block 226, beginning-of-shift countermeasures may be provided that assist the worker in overcoming his or her fatigue, or assist others in working with a fatigued coworker. Such countermeasures may be automatically provided via the risk assessment system upon a determination that the worker is fatigued and beginning a work shift. Alternatively, such countermeasures may be provided to a supervisor or other appropriate personnel with the notification provided at block 224, who may then assist the worker with implementing the countermeasures. Such countermeasures may include any fatigue assistance measures, such as requiring more frequent breaks or resting for a time before beginning a shift. All fatigue countermeasures are contemplated as within the scope of the present disclosure. Table 2 provides an example of the type of countermeasures that may be provided to or implemented by a worker and/or his or her coworkers and/or management, and the criteria for providing such countermeasures:

TABLE 2
Risk ranges and associated countermeasures

| | | | Potential % | | | |
|---|---|---|---|---|---|---|
| Signia | | | exposure and/or | | | |
| Refined | | | diminished | Strategy | | Report |
| (7 point) | Scale | Risk Range | capacity | (7 point) | Specific Strategy | (Flag) |
| Normal | 10 | 9.51-10+ | 0% | Optimal | No fatigue measures | No |
| | 9 | 8.51-9.50 | 5% | | | warning |
| | 8 | 7.51-8.5 | 10% | | | report |
| Low | 7 | 6.51-7.5 | 15% | Maintain | Minimal awareness | |
| | 6 | 5.51-6.5 | 20% | | management | |
| | 5 | 4.51-5.5 | 25% | | | |
| Guarded | 4 | 3.51-4.5 | 30% | Protect | Watch for tiredness | |
| | 3 | 2.51-3.5 | 35% | | Be attentive to fatigue | |
| | 2 | 1.51-2.5 | 40% | | | |
| Significant | 1 | 0.51-1.5 | 45% | Guard | Shield from excessive heat | Warning |
| | 0 | 0.51-(−0.50) | 50% | | Defend against boredom | report |
| | −1 | −0.51-(−1.50) | 55% | | Watch food intake | |
| | | | | | Caffeine - ½ cup coffee | |
| | | | | | Wash hands/face | |
| | | | | | Maintain cool temperature | |
| | | | | | (<68 F.) | |
| | | | | | Bright lights (10K lux − 5 | |
| | | | | | min. − 3 hours before end of | |
| | | | | | shift) | |
| | | | | | Job swap every 6 hours | |
| | | | | | Chewing gum | |
| | | | | | Isometrics | |
| High | −2 | −1.51-(−2.50) | 60% | Proactive | Keep active at all times | Issue flag |
| | −3 | −2.51-(−3.50) | 65% | | Control intakes of protein | alert - |
| | −4 | −3.51-(−4.50) | 70% | | Maintain communication | Report to |
| | | | | | Aerobics | supervisor |
| | | | | | Caffeine - full cup coffee | |
| | | | | | Wash hand/feet/face | |
| | | | | | Short nap | |
| | | | | | Job swap every 4 hours | |
| | | | | | Bright lights (10K lux − 10 | |
| | | | | | min. − 3 hours before end of | |
| | | | | | shift) | |
| | | | | | Maintain cool temperature | |
| | | | | | (<65 F.) | |
| Severe | −5 | −4.51-(−5.50) | 75% | Vigilant | Must be accompanied | |
| | −6 | −5.51-(−6.50) | 80% | | Nap during breaks | |
| | −7 | −6.51-(−7.50) | 85% | | Full fluid intake | |
| | | | | | Longer nap | |
| | | | | | Bright lights (10K lux − 20 | |
| | | | | | min. − 3 hours before end of | |
| | | | | | shift) | |
| | | | | | Lukewarm/cold shower | |
| | | | | | Job swap every 2 hours | |
| Extreme | −8 | −7.51-(−8.50) | 90% | Priority 1 | Must not proceed | |
| | −9 | −8.51-(−9.50) | 95% | | Contact supervisor for policy | |
| | −10 | −9.51-(−10+) | 100% | | No authorization | |

Table 2 also illustrates how reporting may be required or implemented based on fatigue or alertness levels. Note, however, that any countermeasures and/or reporting may be provided based on any criteria. In some embodiments, a supervisor or other appropriate personnel may be required to sign off or provide an authorization before a worker can proceed with a shift. The authorization may provide verification by the supervisor that the worker has performed the required countermeasures before starting work. A supervisor or other appropriate personnel may be required to record the worker's identity, the time of day, the risk range or level, and/or the acknowledged countermeasures performed. Such observations and data may be stored a log which when complete is entered into a risk assessment system database, or such data may be entered into such a database directly by the supervisor or other personnel. Requirements for compliance with countermeasures may be discretionary, and adherence or acknowledgement of the performance of countermeasures may vary, depending on job classification.

If a worker is at the end of a shift, at block 214, the appropriate personnel may be alerted to the worker's unsafe fatigue determination. Because the worker is at the end of a shift, the worker's immediate supervisor may not be notified, and instead a human resources officer or safety officer may be notified, who may then perform an in-person evaluation of the worker before allowing him or her to leave work. Other personnel that are suited for addressing fatigued workers after a work shift may be notified. The notification may include a print out that the worker is required to supply to appropriate personnel, or an email, text message, “Tweet”, automated voice message, or other electronic communication may be transmitted to appropriate personnel. Any means of notifying the appropriate personnel may be used.

At block 216, end-of-shift countermeasures may be provided that assist the worker in overcoming his or her fatigue, or assist others in enabling a fatigued coworker to leave work safely. Such countermeasures may be automatically provided via the risk assessment system upon a determination that the worker is fatigued and ending a work shift. Alternatively, such countermeasures may be provided to the appropriate personnel with the notification provided at block 214, who may then assist the worker with implementing the countermeasures. Such countermeasures may include similar countermeasures as those shown in Table 2, or any other fatigue assistance measures, such as requiring a worker to find a way home other than driving himself or herself home. All fatigue countermeasures are contemplated as within the scope of the present disclosure.

If a worker is currently working a shift, at block 228, the appropriate personnel may be alerted to the worker's unsafe fatigue determination. Because the worker is currently working a shift, the worker's immediate supervisor, foreman, or other personnel who work with or supervise the worker during a shift may be notified. The notified personnel may then perform an in-person evaluation of the worker before allowing him or her to continue work. Other personnel that are suited for addressing fatigued workers during a work shift may be notified. The notification may include a print out that the worker is required to supply to appropriate personnel, or an email, text message, “Tweet”, automated voice message, or other electronic communication may be transmitted to appropriate personnel. Any means of notifying the appropriate personnel may be used.

At block 230, during-shift countermeasures may be provided that assist the worker in overcoming or mitigating his or her fatigue during the shift, or assist others in enabling a fatigued coworker to continue to work safely. Such countermeasures may be automatically provided via the risk assessment system upon a determination that the worker is fatigued and currently working a shift. Alternatively, such countermeasures may be provided to the appropriate personnel with the notification provided at block 228, who may then assist the worker with implementing the countermeasures. Such countermeasures may include similar countermeasures as those shown in Table 2, or any other fatigue assistance measures, such as requiring a worker to stop working. All fatigue countermeasures are contemplated as within the scope of the present disclosure.

At block 218, the assessed risk levels of a worker, whether safe or unsafe, or whether the worker is beginning or ending a shift, may be recorded and stored for future via any effective means, including those described in regard to block 204.

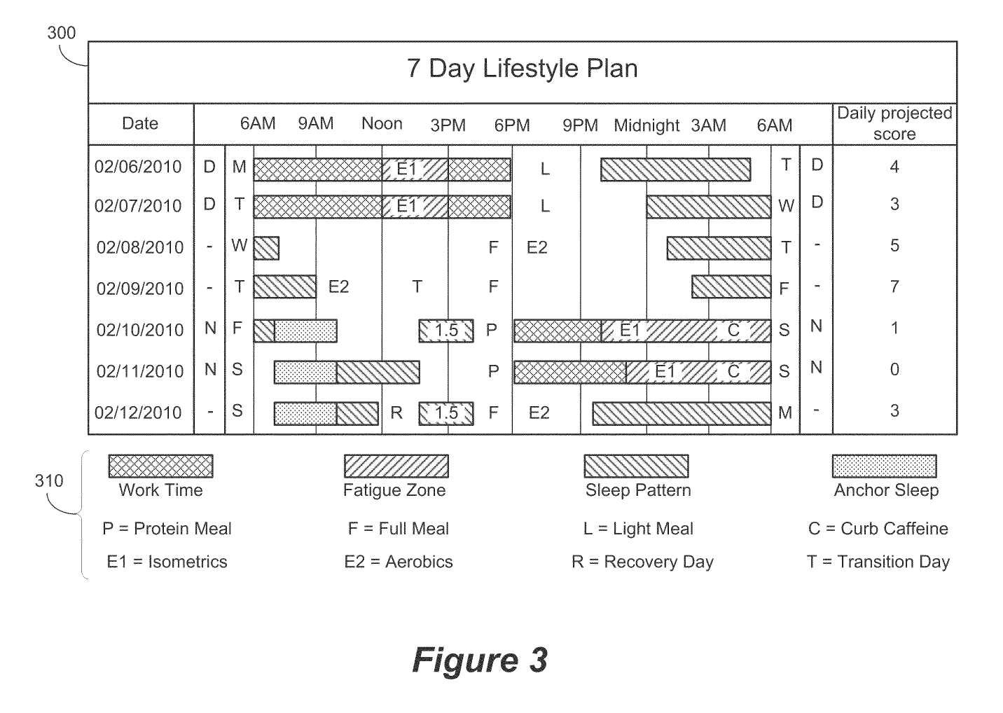

At block 220, a lifestyle plan for a future time period may be generated and provided to a worker. Note that such plans may be provided only at the end or the beginning of shifts, or such plans may be provided during a shift or on-demand. Such a plan may be based on accumulated data for the worker, including the most recently collected data, obtained through the worker's interaction with the risk assessment system. The lifestyle plan may include guidance on how to maintain or improve alertness and reduce fatigue over the course of a number of subsequent days. For example, at the time of punch-in or punch-out, a worker may receive a paper copy of a lifestyle plan (that may be printed out on a printer communicatively connected to a risk assessment system) for the next seven days. The lifestyle plan may provide guidelines for optimizing alertness and reducing fatigue given the worker's particular schedule. In generated such a plan at block 220, a risk assessment system may take into account shifts and hours of work already scheduled for the worker. Alternative means of providing a lifestyle plan are contemplated, such as sending such a plan via email, presenting the plan on a webpage that the worker can access at work, home, and/or on a mobile communications device, etc. An example lifestyle plan is illustrated in FIG. 3 and described in more detail below. Any form of lifestyle plan is contemplated, and any information that may assist a worker in reducing fatigue may be included in any such plan.

At block 222, a management view of risk assessment data and results may be generated and presented to a user of a risk assessment system, such as a supervisor or human resources officer. Such a view may include aggregated information about a group of workers and/or detailed information about a particular worker. Also at block 222, reports may be generated and presented to a risk assessment system user, such as reports illustrating trends and reports highlighting areas of a business and their corresponding fatigue data. Any type of report, view, data, illustrations, or other information that may be of use to a manager, supervisor, or other operator of a risk assessment system may be generated and presented at block 222.

Note that method 200 may return to block 206, or any other block of method 200, after performing the activities of block 222, or at any point during the performance of method 200. In some embodiments, risk calculations and/or analysis performed in block 206 or any other such calculations and/or analysis may be continuously performed and risk, fatigue, alertness, and/or any other data may be continuously updated and monitored. In such embodiments, notifications may be automatically generated based on such data, thereby providing a means to track any such data in real-time and trigger notifications early as possible, thus reducing the likelihood of accidents or dangerous conditions.

FIG. 3 illustrates exemplary, non-limiting lifestyle plan 300 that may be generated, for example, at block 220 of method 200 shown in FIG. 2, and provided to a worker. Lifestyle plan 300 may cover any number of days or other time period, and may provide any type of suggestions, recommendations, requirements, and/or guidance for a worker's sleep habits, diet, exercise, etc. Lifestyle plan 300 may display such information graphically for ease of reference. Graphical representation of lifestyle plan information may be interpreted through the use of legend 310. In the example illustrated in FIG. 3, a week time period is shown, with the date and days listed as well as the shift assigned per day (‘D’ for day shift, ‘N’ for night shift, ‘−’ for off days.) Bars are displayed which indicate time periods for various activities or characteristics. As shown in FIG. 3, sleep periods and work periods are illustrated. Periods of time within sleep periods and work periods may also be highlighted. For example, as seen in FIG. 3, anchor sleep periods are indicated, which are periods of sleep that a shift worker is recommended to maintain regardless of shift. Also seen in FIG. 3 are predicted periods of fatigue. The indicated periods (sleep, anchor sleep, fatigue) on lifestyle plan 300 may be generated by a risk assessment system upon analysis of the worker's recent work schedule and/or other behavior and tasks.

Lifestyle plan 300 may also indicate when certain activities should take place. For example, lifestyle plan 300 as shown in FIG. 3 indicates when meals should be eaten and what types of meals, such as light meals, full meals, or protein meals. Lifestyle plan 300 may also indicate when to avoid certain foods or activities, such as caffeine. In some embodiments, lifestyle plan 300 may indicate when exercise should be performed, and what type of exercise, for example, aerobic or isometric exercise. Other indicator may be used on a lifestyle plan, including an indicator for a recovery day.

Lifestyle plan 300 may also indicate a predicted fatigue or alertness score. Such a predicted score may be based on an assumption that the worker has followed the lifestyle plan through the day for which the predicted fatigue or alertness score has been generated. Such scores may be generated using the same methods and systems that are used as described herein to generate real-time fatigue or alertness scores. Any other information may be presented in a lifestyle plan, and such a plan may be presented in any format, including on paper, transmitted by email or other data communications, or presented on a webpage. All such lifestyle plans are contemplated as within the scope of the present disclosure.

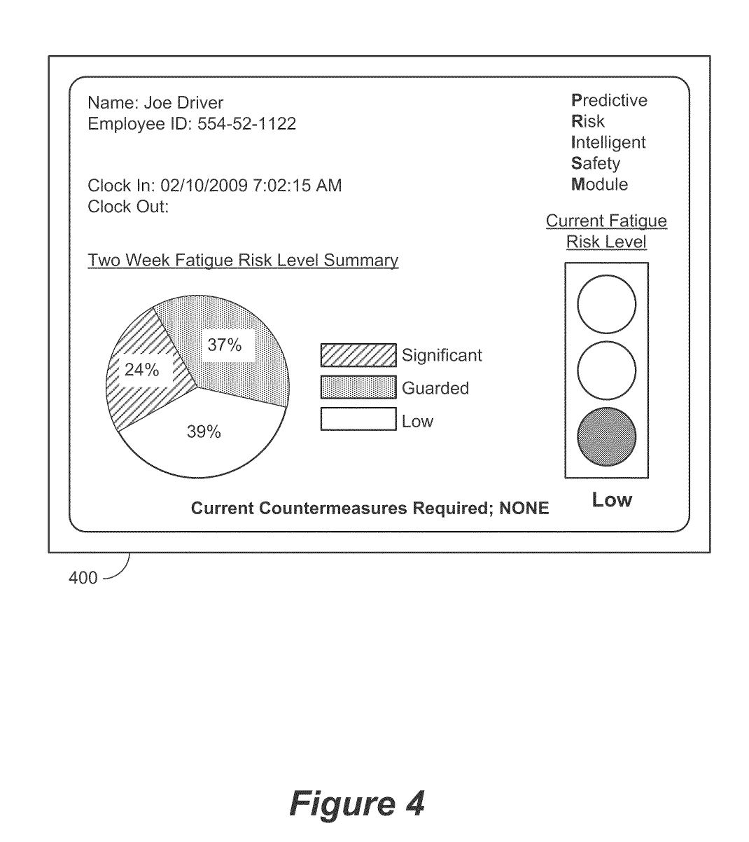

FIG. 4 illustrates view 400 that may be presented to a worker at the time the worker punches-in or punches-out, or when a worker otherwise interacts with a risk assessment system. View 400 may include a variety of information, including, as seen in FIG. 4, a display of the worker's name and identification number. View 400 may also include a history of risk assessment data for the particular worker. For example, data from a predetermined time period, such as two weeks as shown on view 400, may be aggregated and displayed to a worker in a graphical format. A legend may also be presented to assist the worker in interpreting the historical data presented. In the non-limiting example shown in view 400, Joe Driver has been in the “Significant” risk range for 24% of the past two weeks, the “Guarded” risk range for 37% of the past two weeks, and the “Low” risk range for 39% of the past two weeks. Any other method or means of presenting historical data, whether on-demand or automatically, for a particular worker may be used, and all such embodiments are contemplated as within the scope of the present disclosure.

View 400 may also display the currently determined fatigue risk range or level of the worker. An actual range may be presented, and/or the risk category associated with the determined range. A simple graphical display may also be used to indicate to the user in an easily interpreted format that the worker is or is not safe to proceed with work. In the non-limiting example illustrated in FIG. 4, Joe Driver has a “Low” fatigue risk level, which is explicitly indicated. This level is also reflected in a stop-light graphic, which shows the green light lit, readily indicating to Joe Driver that he is approved to proceed with work. Any other means or methods of providing a current risk range, level, or other risk-related information, may be employed and all such means and methods are contemplated as within the scope of the present disclosure.

View 400 may also list countermeasures as described above based on the determined risk range or fatigue level. For example, should a worker be determined to be in an unsafe state of fatigue, view 400 may instruct the worker to get supervisor approval before proceeding and/or perform other countermeasures.

Note also that a worker may access a view such as view 400 at various time, not only at punch-in and punch-out. For example, a worker may log into his or her employer's website (from home, work, or elsewhere) and request current fatigue risk data, which may be presented on a webpage. Alternatively, the information presented in view 400 may be also be presented audibly. This allows for a worker to call a telephone number and listen to a voice recording (in one embodiment, computer-generated) conveying the information shown in view 400. In another embodiment, the present systems and methods may be combined with text, email, and/or other electronic messaging technologies such that a worker can transmit an email or a text message to a device that is communicatively connected to a risk assessment system and request information such as that shown in view 400. The risk assessment system may then respond in kind with a text message or email containing the information requested. In an alternate embodiment, the system may respond to an email or a text message with a call or a link to a webpage. Such options may be user or administer configurable. Any other means of methods of requesting and obtaining current and historical risk ranges, fatigue levels, and/or any other data may be employed, and all such means and methods are contemplated as within the scope of the present disclosure.

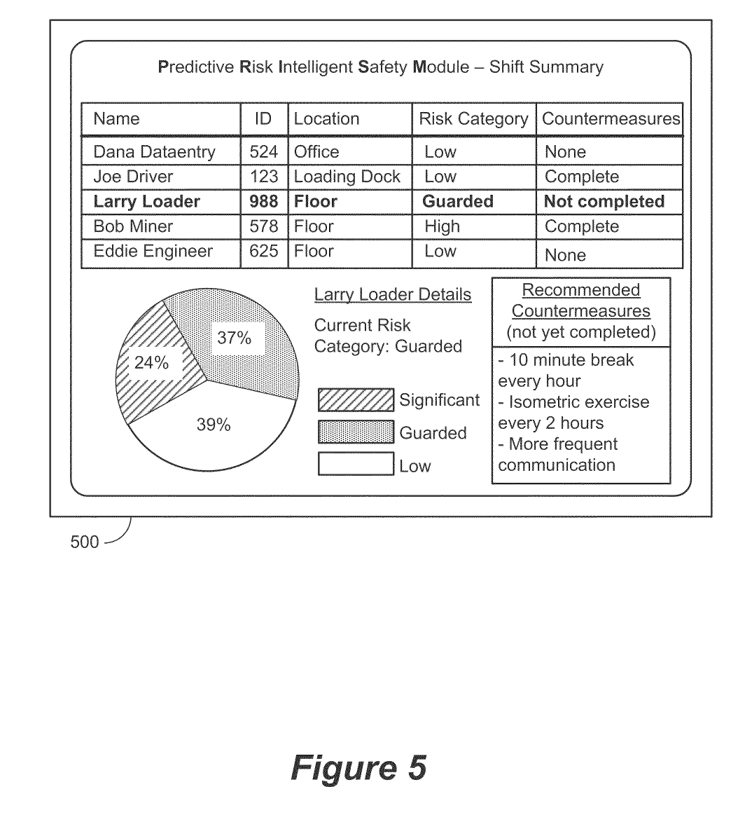

FIG. 5 illustrates view 500 that may be presented to a manager, supervisor, or any person who may require aggregated data relating to the risk assessment results of an organization or group of workers. As seen in view 500, a view may be presented that provides a listing of several workers, in one embodiment, those workers currently working, clocked-in, or otherwise active at the workplace. Identification and work data may be provided about each of the workers, including names, identification numbers, and current location. Risk data may also be provided. This may include the worker's current risk category as well as whether each worker requires countermeasures and whether the worker has performed the required countermeasures. Alternatively, graphical elements may be used to show aggregate data, such as pie charts or bar graphs that summarize the risk categories of a work group as a whole. Any other display, graphical element, or other means of conveying aggregated data may be employed, and all such means are contemplated.

Through view 500, a user of such a view may drill down to subsets of the workforce, and/or down to individual worker data. For example, as seen in view 500, when Larry Loader is selected or highlighted in view 500, Larry Loader's risk details are displayed on the lower section of the view. In other embodiments, Larry Loader's risk details may be presented in a separate window or on a view or screen that replaces view 500. Any alternate means of viewing drill-down data is contemplated. The details provided for Larry Loader may include anything as described in regard to FIG. 4, including historical risk data, current risk data, countermeasures recommended, and whether or not such countermeasures have been completed. Any other details about Larry Loader may be presented, and all such details are contemplated as within the scope of the present disclosure.

A risk assessment system may also provide reports based on, or separate from, the views shown in FIGS. 4 and 5. Any aggregation or subset of fatigue risk data and related data may be presented in a report. Such reports may be generated on-demand or automatically generated based on a schedule or a detected trigger. Such reports may be provided via any means, including printed out on paper, presented on a computer monitor, transmitted via email or other data communications means, imported into a spreadsheet, etc. Any reporting means and/or type of report is contemplated as within the scope of the present disclosure.

Note that the views illustrated herein on FIGS. 4 and 5 as well as the lifestyle plan of FIG. 3 and any other information that may be conveyed to a user, operator, worker, or any other person that interacts with a risk assessment system or implements the risk assessment methods as described herein may be presented on any type of visual display, including televisions, computer monitors, mobile communications device display, or any other type of visual display, and may be presented within a webpage or through other software. Such data and information may also be presented audibly through recorded or computer-generated voice transmissions. Any alternative means and methods of presenting information may be used, and all such means and methods are contemplated as within the scope of the present disclosure.

It is to be understood that the embodiments and claims are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A fatigue risk assessment system comprising:
a worker interface device;
a risk analysis device comprising software and hardware, the risk analysis device configured to, upon activation of the worker interface device:
determine a work history of a worker;
determine fatigue risk data of the worker based on the work history; and
an output device configured to present the fatigue risk data and the lifestyle plan to the worker.

2. The system of claim 1, wherein the risk analysis device is further configured to determine a risk category based on the fatigue risk data.

3. The system of claim 1, wherein the risk analysis device is further configured to determine a lifestyle plan.

4. The system of claim 1, wherein the worker interface device is configured to obtain a current time associated with the worker beginning or ending a work period, and transmit the current time to a time tracking system.

5. The system of claim 1, wherein the risk analysis device is configured to receive a request for the fatigue risk data of the worker from a remote device, and, responsive to receiving the request, transmit the fatigue risk data to the remote device.

6. The system of claim 5, wherein the remote device is a telephone, and wherein transmitting the fatigue risk data to the remote device comprises transmitting an audible signal comprising the fatigue risk data to the remote device.

7. The system of claim 5, wherein the remote device is a computer executing a web browser, and wherein transmitting the fatigue risk data to the remote device comprises transmitting a web page to the remote device.

8. The system of claim 1, wherein the risk analysis device is further configured to determine fatigue countermeasures based the risk category, and wherein the output device is further configured to present the countermeasures to the worker.

9. The system of claim 1, wherein the risk analysis device is further configured to receive a request for aggregate fatigue risk data, and, responsive to receiving the request, present the aggregate fatigue risk data.

10. The system of claim 9, wherein the aggregate fatigue risk data comprises a selectable control associated with the worker, and wherein the risk analysis device is further configured to, responsive to detecting the selection of the selectable control, present the fatigue risk data of the worker.

11. A method for performing fatigue risk assessment, the method comprising:
receiving a request to provide fatigue risk data for a worker at a worker interface device;
determining an identity of the worker;
determining historical work data based on the identity;
determining, on a risk assessment device, the fatigue risk data for the worker based on the historical work data;
presenting the fatigue risk data on an output device;
associating the fatigue risk data with the historical work data; and
storing the fatigue risk data on a storage device.

12. The method of claim 11, wherein the request comprises a time stamp and an indication of a beginning or end of a work shift, and wherein determining the fatigue risk data for the worker comprises determining the fatigue risk data for the worker based on the time stamp, the indication, and the historical work data.

13. The method of claim 11, further comprising determining, on the risk assessment device, a fatigue risk category based on the fatigue risk data.

14. The method of claim 11, further comprising determining that the request is received at the end of a work shift of the worker, and generating countermeasures based said determination.

15. The method of claim 11, further comprising determining that the request is received at the beginning of a work shift of the worker, and generating countermeasures based said determination.

16. A computer-readable storage medium comprising computer-executable instructions for performing fatigue risk assessment, the computer-executable instructions comprising instructions for:
receiving a request to provide fatigue risk data for a worker;
determining an identity of the worker;
determining a time;
transmitting the identity and the time to a time keeping system;
determining historical work data based on the identity;
determining, on a risk assessment device, the fatigue risk data for the worker based on the historical work data; and
presenting the fatigue risk data on an output device.

17. The computer-readable storage medium of claim 16, further comprising instructions for:
generating a lifestyle plan based on the historical work data and the fatigue risk data; and
presenting the lifestyle plan on an output device.

18. The computer-readable storage medium of claim 17, wherein the lifestyle plan comprises for at least one of a recommended sleep period, recommended exercise, and recommended diet.

19. The computer-readable storage medium of claim 16, further comprising presenting the historical work data on the output device.

20. The computer-readable storage medium of claim 16, further comprising instructions for:
determining a fatigue risk category based on the fatigue risk data;
determining that the fatigue risk category is associate with an unsafe risk; and
presenting the fatigue risk data on an output device with instructions that the worker must seek management approval before performing work.
